(19) United States
(12) Patent Application Publication
(10) Pub. No.: US 2002/0077250 A1
(43) Pub. Date: Jun. 20, 2002

(54) Process for preparing aryl compounds

(76) Inventors: Markus Eckert, Koln (DE); Guido Giffels, Bonn (DE); Hans-Christian Militzer, Odenthal (DE); Thomas Prinz, Leverkusen (DE)

Correspondence Address: BAYER CORPORATION, PATENT DEPARTMENT, 100 BAYER ROAD, PITTSBURGH, PA, 15205, US

(21) Appl. No.: 09/962,258

(22) Filed: Sep. 24, 2001

(30) Foreign Application Priority Data
Sep. 26, 2000 (DE) 10047484.5
Apr. 27, 2001 (DE) 10121105.8

(51) Int. Cl. C07F 7/04

(52) U.S. Cl. 502/337; 558/87; 558/56; 564/305; 568/631; 570/190; 556/482

(57) ABSTRACT

The present invention relates to an advantageous preparation of aryl compounds by cross-coupling reaction of a substituted aryl halide compound with a Grignard reagent in the presence of a nickel catalyst wherein the substituted aryl compounds and a novel nickel catalyst are initially placed in a reaction vessel and the Grignard reagent is metered in at the reaction temperature.

### BACKGROUND OF THE INVENTION

The present invention relates to a particularly advantageous process for preparing aryl compounds by cross-coupling reaction of aryl halide compounds with Grignard reagents in the presence of nickel catalysts, for which the method of preparation is likewise subject-matter of the invention.

According to Inorg. Chim. Acta 296, 164 (1999), such reactions are carried out using a heterogeneous nickel-on-carbon catalyst to which, after its preparation, aryl chloride and then, at −78° C., the Grignard reagent (e.g., 4-methoxybenzylmagnesium chloride) are added. The mixture is slowly warmed to room temperature and then heated to reflux. The reaction is generally carried out in the presence of lithium bromide, but this does not appear to be absolutely necessary. A disadvantage of this procedure is the necessity of adding the Grignard reagent at −78° C. Such low temperatures are virtually prohibitive for a process to be carried out on an industrial scale. A further disadvantage is that the reaction is difficult to control by introduction or removal of heat, which, particularly in the case of reactions with Grignard reagents, represents a safety risk since the delayed commencement of the reaction that frequently occurs can liberate a large quantity of heat for which removal then leads to problems.

The precursor materials for the nickel-on-carbon catalysts are prepared with exclusion of air in an argon atmosphere from carbon and aqueous nickel(II) nitrate and have to be stored under inert conditions after they have been isolated (Tetrahedron, 56, 2000, 2139-2144). Before use in the cross-coupling reactions described, the precursor materials are reacted with n-butyllithium or methylmagnesium bromide to reduce the nickel to the oxidation state (0). This method of producing the catalyst is therefore not very suitable for industrial use.

There is therefore still a need for a process for preparing aryl compounds and catalysts suitable for this process, as well as precursor materials thereof, that can be carried out at temperatures which can readily be achieved in industry and without safety risks.

### SUMMARY OF THE INVENTION

We have now found a process for preparing aryl compounds by a cross-coupling reaction of a substituted aryl halide compound with a Grignard reagent in the presence of a nickel catalyst comprising placing the substituted aryl halide compound and the nickel catalyst in a reaction vessel and metering in the Grignard reagent at the reaction temperature.

### DETAILED DESCRIPTION OF THE INVENTION

The preparation according to the invention of aryl compounds by cross-coupling reaction of aryl halide compounds with Grignard reagents using the nickel catalysts, which are likewise subject-matter of the invention, can be illustrated by way of example by the following reaction equation:

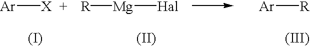

The formula (I) represents the substituted aryl compound used, the formula (II) represents the Grignard reagent used, and the formula (III) represents the aryl compound prepared.

In the formulas (I) and (III), Ar can represent, for example, a substituted or unsubstituted aromatic radical having from 5 to 18 skeletal atoms, wherein the skeletal atoms can be carbon atoms only or carbon atoms plus heteroatoms such as N, O, and/or S atoms. If skeletal heteroatoms are present, the number present per Ar group is, for example, 1, 2, or 3 (preferably 1 or 2). Ar is preferably substituted or unsubstituted phenyl, tolyl, naphthyl, anthryl, phenanthryl, biphenyl, or a 6-membered aromatic radical containing 1 or 2 N atoms.

Possible substituents for Ar are, for example, halogen, C₁-C₆-alkyl, C₁-C₆-alkoxy, C₁-C₆-halogenoalkyl, C₁-C₆-halogenoalkoxy, tri-C₁-C6-alkyl-siloxyl, protected aldehyde groups in the form of acetals or aminals, aryl having from 6 to 10 skeletal atoms that may be carbon atoms only or carbon atoms plus 1 or 2 N, O, and/or S atoms, NR′₂, SO₃R″, SO₂R″, SOR″, SR″, or POR″₂, where the two radicals R′ may be identical or different and may each represent hydrogen, C₁-C₆-alkyl, or C₆-C₁₀-aryl, and R″ may represent C₁-C₆-alkyl or C₆-C₁₀-aryl. One or more, identical or different representatives of these substituents can be present, for example, up to three per Ar.

Ar is preferably carbocylic C₆-C₁₀-aryl that may be unsubstituted or substituted by one or two substituents selected from the group consisting of C₁-C₄-alkyl, C₁-C₄-alkoxy, C₁-C₄-fluoroalkyl, C₁-C₄-chloroalkyl, and phenyl, wherein one or two, identical or different representatives of such substituents can be present.

Particularly preferred substituted aryl compounds are chlorotoluene, chlorobenzonitrile, chloroanisole, chloropyridine, dichlorobenzene, chloro-biphenyl, chloronaphthalene, chlorfluorobenzene, chlorotrifluoromethyl-benzene, and chloro-ethylbenzene.

In the formula (I), X can represent, for example, chlorine, bromine or OR¹, where R¹ represents SO₂R² or CON(R²)₂ in which R² is C₁-C₄-alkyl or C₁-C₄-perhalogenoalkyl (particularly trifluoromethyl).

In the formula (II) and (III), R can represent, for example, substituted or unsubstituted C₁-C₂₆-alkyl, C₂-C1₂-alkenyl, or C5-C₁₈-aryl. The alkenyl groups may, if the number of carbon atoms present makes it possible, be monounsaturated or polyunsaturated and, like the alkyl groups, be either linear or branched or cyclic or contain cyclic substructures. The alkyl, alkenyl, and aryl groups can be unsubstituted or substituted, for example, by from 1 to 5 identical or different substituents selected from the group specified above as substituents for Ar.

In formula (II), Hal is, for example, chlorine or bromine.

Particularly preferred Grignard reagents are ethylmagnesium, propylmagnesium, phenylmagnesium, tolylmagnesium, and p-methoxy-phenylmagnesium chlorides.

It is possible to use, for example, from 0.1 to 3 equivalents of the substituted aryl compound per 1 mol of Grignard reagent. This amount is preferably from 0.8 to 1.5 equivalents, particularly about one equivalent.

The respective Grignard reagent is generally used as a solution in a solvent. Such solutions can have a concentration of, for example, from 15 to 40% by weight. They preferably have a concentration of from 20 to 35% by weight. The Grignard reagent solution can in each case be freshly prepared by known methods.

The substituted aryl compound can also function as solvent. It is then necessary to use it in relatively large amounts, for example, in amounts of up to 20 equivalents (preferably up to 10 equivalents) per mole of Grignard reagent.

The nickel catalysts used according to the invention can be, for example, supported Ni(O) catalysts which have been prepared by loading a support material with the aqueous solution of a nickel compound and reducing the nickel compound using a reducing agent.

Suitable support materials are, for example, activated carbon, aluminum oxides, silicon dioxides, and silicates. The support material can have, for example, an internal surface area of from 10 to 2000 m²/g. Preference is given to using activated carbon having an internal surface area of from 800 to 1600 m²/g or aluminum oxides, silicon oxides, or silicates having internal surface areas of from 100 to 400 m²/g. The solution of a nickel compound is preferably an aqueous solution of, for example, nickel(II) chloride, bromide, acetate, nitrate, or sulfate or mixtures thereof.

The loading of the support material can be carried out, for example, by impregnating the support material with an aqueous solution of one or more nickel compounds and, optionally after separating off excess solution, drying and/or heating the loaded support material. The temperature can be, for example, from 1500 to 400° C., preferably from 170 to 300° C. In this way, for example, nickel nitrate can be converted into nickel oxide. A further possibility is to load the support material in the presence of an aqueous solution of one or more nickel compounds and in the presence of a base. In this case, it is possible, for example, for the support material, together with an aqueous solution of one or more nickel compounds, to be placed in a reaction vessel first and the base to be added subsequently or for an aqueous solution of one or more nickel compounds to be added to an aqueous suspension of the support material and a base. Simultaneous addition of base and an aqueous solution of one or more nickel compounds to an aqueous suspension of the support material is, for example, also possible. Examples of bases that can be used are alkali metal oxides, hydroxides, or carbonates and also alkaline earth metal hydroxides, preferably alkali metal hydroxides, particularly preferably sodium hydroxide and potassium hydroxide. Drying and/or heating at from 150 to 400° C. (preferably from 170 to 300° C.) then gives oxidic catalyst precursor materials that are insensitive to oxygen and therefore do not have to be stored under a protective gas atmosphere.

The reduction can, for example, be carried out in the aqueous phase during loading, e.g., by direct addition of the reducing agent. However, reduction can also be carried out after drying and/or heating of the loaded support material.

The nickel(0)-containing catalysts are also stable in air while moist with water. Before being used in the cross-coupling reactions of the invention, the moist catalysts should be dried, for example by heating and/or application of a vacuum. The advantage of the nickel catalysts used according to the invention and their precursor materials is that they can be prepared without use of organic solvents and inert conditions.

Suitable reducing agents are aqueous solutions of, for example, hydrazine and formaldehyde. If Ni(II) precursor materials are used in the cross-coupling, the reduction can, for example, be carried out using organolithium compounds such as n-butyllithium, hydrogen, or in-situ using the Grignard reagent employed. In this case, the advantage is that the catalyst precursor materials are stable in air, which considerably simplifies handling, especially in industry.

The finished supported nickel catalyst or the precursor materials can contain, for example, from 0.5 to 100 g of nickel per kg, preferably from 0.5 to 50 g of nickel per kg, particularly preferably from 0.5 to 10 g of nickel per kg, and very particularly preferably from 2 to 5 g of nickel per kg.

Based on 1 mol of Grignard reagent, the amount of supported nickel catalyst used in the cross-coupling reaction of the invention can, for example, correspond to from 0.001 to 0.2 mol of nickel (calculated as metal). This amount is preferably from 0.005 to 0.05 mol.

The process of the invention can be carried out, for example, by placing the substituted aryl compound, the nickel catalyst and any solvent to be used in a reaction vessel, for example, at from 0 to 25° C., then bringing this mixture to the reaction temperature, for example, to from 0 to 150° C., and then metering in the Grignard reagent.

It is an essential feature of the present invention that the Grignard reagent is added at the reaction temperature and not as previously, where the total amount of Grignard reagent is added at low temperature and the temperature is then raised to the reaction temperature.

The reaction temperature is preferably from 20 to 120° C., in particular from 35 to 100° C.

The process of the invention can also be carried out by initially charging only part of the intended amount of substituted aryl compound (e.g., from 20 to virtually 100%) together with the nickel catalyst and any solvent to be used and then adding the remainder of the aryl compound during the introduction of the Grignard reagent.

After all of the Grignard reagent has been metered in, the mixture can be stirred for a further time at, for example, from 0 to 150° C.

If temperatures above the boiling point at atmospheric pressure of a constituent of the reaction mixture are to be employed, the reaction can be carried out under superatmospheric pressure. Preference is given to carrying out the reaction at atmospheric pressure under reflux or in a closed vessel at the autogenous pressure established at the respective temperature.

Suitable solvents for the process of the invention are, for example, aromatic solvents such as monoalkylbenzenes and polyalkylbenzenes and ethers such as diethyl ether, tert-butyl methyl ether, and tetrahydrofuran. Preference is given to tetrahydrofuran. As mentioned above, an excess of substituted aryl compound can also serve as solvent.

In a particular embodiment of the process of the invention, the reaction is carried out in the additional presence of a phosphorus-containing component. This can be, for example, an organic phosphorus compound, particularly a diarylphosphine, triarylphosphine, dialkyl-phosphine, trialkylphosphine, diaryl phosphite, triaryl phosphite, dialkyl phosphite, or trialkyl phosphite. Specific examples of phosphorus-containing components are triphenylphosphine, triphenyl phosphite, tritolylphosphine, bis(diphenylphosphino)ethane, 1,4-bis(diphenylphosphino)butane, 1,3-bis(triphenylphosphino)propane, tri-tert-butylphosphine, tricyclohexylphosphine, and tris(2,4-di-tert-butylphenyl) phosphite.

If a phosphorus-containing component is used, it can be used in an amount of, for example, from 0.1 to 20 mol per 1 mol of nickel in the catalyst. The addition of a phosphorus-containing component frequently enables higher reaction rates and/or better selectivities to be achieved.

To work up the reaction mixture, it is possible, for example, to admix it with water or an alcohol (e.g., a C₁-C₄-alkyl alcohol), filter off the solid constituents and wash them with, for example, the solvent used in the reaction. The filtrate and the washings can then be combined and the solvents present therein can be taken off. Distillation of the residue in a high vacuum can then give the aryl compound in yields of generally above 85% of theory and in purities of above 95%.

The catalyst used can, for example, be recovered by filtering the reaction mixture at the end of the reaction and before addition of water or alcohol and washing the catalyst which has been isolated in this way, e.g., with water, and drying it. It can then be reused in the process of the invention or be used in some other way.

Compounds that can be prepared according to the invention are suitable, for example, for use as liquid-crystalline materials and as intermediates for such materials. They are also intermediates for pharmaceuticals, agrochemicals (e.g., fungicides and herbicides), pigments, and surface coatings.

The process of the invention has the advantage that the course of the reaction can be controlled by metered addition of the Grignard reagent. This method of controlling the reaction is simple and poses no safety problems. It was not to be foreseen that this change in the process procedure could be achieved without disadvantages in respect of the reactivity and selectivity of the catalyst. In the process of the present invention, the concentration of the Grignard reagent in the reaction mixture is always at a very low level, whereas according to the prior art the Grignard reagent is present in a high concentration at the beginning of the reaction and then steadily decreases. The concentration of a reactant in the reaction mixture is known to have a very strong influence on the course of reactions.

Furthermore, the process of the invention has the advantage that it is carried out without employing low temperatures.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Preparation of Supported Nickel Catalysts to be Used According to the Invention

### Example 1

98 g of an activated carbon having an internal surface area of 1600 m²/g were mixed with a solution of 9.1 g of Ni(NO₃)₂×6 H₂O in 100 ml of water for 30 minutes. The mixture was dried at 100° C. in a stream of nitrogen and subsequently heated at 170° C. for 1 hour. The solid was subsequently reduced in a stream of hydrogen at 450° C.

### Example 2

98 g of an activated carbon having an internal surface area of 1600 m²/g were mixed with a solution of 9.1 g of Ni(NO₃)₂×6 H₂O in 100 ml of water for 30 minutes. The mixture was dried at 100° C. in air and subsequently heated at 170° C. for 1 hour.

### Examples 3 to 5

98 g of a support were slurried in 600 ml of water, admixed with a solution of 8.1 g of NiCl₂×6 H₂O in 50 ml of water, and the mixture was stirred for another 30 minutes. The pH was then brought to 10 by means of a 5% strength aqueous sodium hydroxide solution and the mixture was stirred for another 1 hour. The catalyst was filtered off, washed with water until free of chloride, and subsequently dried at 100° C. under reduced pressure for 1 hour.

The supports were activated carbon having an internal surface area (BET) of 800 m²/g in Example 3, silicon dioxide having an internal surface area (BET) of 300 m²/g in Example 4, and aluminum oxide having an internal surface area (BET) of 150 m²/g in Example 5.

### Coupling Reactions According to the Invention

### Example 6

Under nitrogen, 0.75 g of the catalyst from Example 1 was placed in a reaction vessel, 0.52 g of triphenylphosphine and 3.26 g of 3-chlorotoluene (97% pure) in 15 ml of absolute tetrahydrofuran (THF) were added, and the mixture was heated to 50° C. At 50° C., 13.8 ml of a 2 molar solution of phenylmagnesium chloride in THF were added dropwise over a period of 2 hours while stirring. The mixture was subsequently refluxed for 12 hours. After cooling to room temperature, 10 ml of ethanol were added, the reaction mixture was filtered, the filter cake was washed with THF, and the filtrate was evaporated. The residue was distilled under a high vacuum. This gave 3.6 g of 3-methylbiphenyl (83% of theory, purity 97%).

### Example 7

Under nitrogen, 0.75 g of the catalyst from Example 1 were placed in a reaction vessel, 0.52 g of triphenylphosphine and 3.26 g of 3-chlorotoluene in 15 ml of THF were added, and the mixture was heated to reflux. Under reflux, 25 ml of a 2 molar solution of phenylmagnesium chloride in THF were added dropwise over a period of 2 hours while stirring. The mixture was subsequently refluxed for 12 hours. After cooling to room temperature, 10 ml of ethanol were added, the reaction mixture was filtered, the filter cake was washed with THF, and the filtrate was evaporated. The residue was distilled under a high vacuum. This gave 4.1 g of 3-methylbiphenyl (96% of theory, purity 98%).

### Example 8

The procedure of Example 6 was repeated but without addition of triphenylphosphine. 2.85 g of 3-methylbiphenyl having a purity of 96% were obtained. This corresponds to a yield of 65% of theory.

### Example 9

The procedure of Example 6 was repeated except for using 4-chloroanisole (25 mmol) as starting material. 4.0 g of 3-methoxybiphenyl having a purity of 98% were obtained. This corresponds to a yield of 85% of theory.

### Example 10

The procedure of Example 6 was repeated except for using the catalyst from Example 5. 3.8 g of 3-methylbiphenyl having a purity of 97% were obtained. This corresponds to a yield of 88% of theory.

### Example 11

The procedure of Example 7 was repeated except that triphenyl phosphite was used in place of triphenylphosphine. 3.3 g of 3-methyl-biphenyl having a purity of 94% were obtained. This corresponds to a yield of 74% of theory.

### Example 12

The procedure of Example 6 was repeated except for using the catalyst from Example 2. 3.7 g of 3-methylbiphenyl having a purity of 97% were obtained. This corresponds to a yield 85% of theory.

### Example 13

Under an argon atmosphere, 0.75 g of the catalyst obtained as described in Example 1 was placed in a reaction vessel, and first 0.52 g of triphenylphosphine and then 3.26 g of 3-chlorotoluene (97% pure) dissolved in a mixture of 5 ml of THF and 10 ml of toluene were added. The mixture was heated to reflux and maintained at the reflux temperature. 13.8 ml of a 2 molar solution of phenylmagnesium chloride in THF were added dropwise over a period of 3 hours while stirring and the mixture was stirred for another 3 hours. After cooling to room temperature, 3 ml of water were added slowly while cooling and the catalyst was filtered off. The filtrate was partitioned between water/toluene and the organic phase was evaporated. The residue which remained was distilled under a high vacuum. This gave 3.7 g of 3-methylbiphenyl having a purity of 97%, which corresponds to a yield of 85% of theory.

### Example 14

Example 13 was repeated using the catalyst from Example 3. 3.8 g of 3-methylbiphenyl having a purity of 95% were obtained. This corresponds to a yield of 86% of theory.

### Example 15

Example 13 was repeated using 4-chloroanisole and 4-tolyl-magnesium chloride as starting materials. 4.2 g of 4-methoxy-4′-methyl-biphenyl having a purity of 95% were obtained. This corresponds to a yield of 80% of theory.

### Example 16

Example 13 was repeated using the catalyst from Example 4. 3.5 g of 3-methylbiphenyl having a purity of 94% were obtained. This corresponds to a yield of 78% of theory.

### Example 17

Under an argon atmosphere, 0.75 g of the catalyst obtained as described in Example 1 and 0.52 g of triphenylphosphine were placed in a reaction vessel and suspended in 10 ml of THF. The suspension was brought to 65° C. while stirring and 3.26 g of 3-chlorotoluene (97% pure, 25 mmol) and 13.8 ml of a 2 molar solution of phenylmagnesium chloride in THF were added dropwise in parallel, the first over a period of 1 hour and the second over a period of 2 hours. The mixture was subsequently stirred for another 5 hours at 65° C. Work-up as described in Example 18 gave 3.9 g of 3-methylbiphenyl having a purity of 97%. This corresponds to a yield of 90% of theory.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing aryl compounds by cross-coupling reaction of a substituted aryl halide compound with a Grignard reagent in the presence of a nickel catalyst comprising placing the substituted aryl halide compound and the nickel catalyst in a reaction vessel and metering in the Grignard reagent at the reaction temperature.

2. A process according to claim 1 wherein
(1) the substituted aryl halide compound has the formula (I)
Ar—X (I)
wherein Ar represents a substituted or unsubstituted aromatic radical having from 5 to 18 skeletal atoms, wherein the skeletal atoms are carbon atoms only or carbon atoms plus heteroatoms,
where the substituents on Ar, when substituted, are halogen, C₁-C₆-alkyl, C₁-C₆-alkoxy, C₁-C₆-halogenoalkyl, C₁-C₆-halogenoalkoxy, tri-C₁-C₆-alkyl-siloxyl, protected aldehyde groups in the form of acetals or aminals, aryl having from 6 to 10 skeletal atoms where the skeletal atoms of aryl are carbon atoms only or carbon atoms plus N, O, and/or S atoms, NR′₂ where the two radicals R′ are identical or different and each represent hydrogen, C₁-C₆-alkyl, or C₆-C₁₀-aryl, or SO₃R″, SO₂R″, SOR″, SR″, or POR″₂ where R″ represents C₁-C₆-alkyl or C₆-C₁₀-aryl
(2) the Grignard reagent used has the formula (II)
R—Mg—Hal (II)
wherein
R represents substituted or unsubstituted C₁-C₂₆-alkyl, C₂-C₁₂-alkenyl or C₅-C₁₈-aryl, wherein the substituents on R, when substituted, are defined as for the substituents for the radical Ar of formula (I), and
Hal represents chlorine or bromine, and
(3) the aryl compound product has the formula (III)
Ar—R (III)
wherein Ar is defined as for formula (I) and R is defined as for formula (II).

3. A process according to claim 2 wherein the compound of the formula (I) is chlorotoluene, chlorobenzonitrile, chloroanisole, chloro-pyridine, dichlorobenzene, chlorobiphenyl, chloronaphthalene, chloro-fluorobenzene, or chlorotrifluoromethylbenzene and the compound of the formula (II) is ethylmagnesium chloride, propylmagnesium chloride, phenylmagnesium chloride, tolylmagnesium chloride, or p-methoxy-phenylmagnesium chloride.

4. A process according to claim 1 wherein from 0.1 to 3 equivalents of the substituted aryl halide compound are used per 1 mol of Grignard reagent.

5. A process according to claim 1 wherein the amount of supported nickel catalyst used per 1 mol of Grignard reagent corresponds to from 0.01 to 0.2 mol of nickel (calculated as metal).

6. A process according to claim 1 carried out at temperatures in the range from 0 to 150° C.

7. A process according to claim 1 carried out at from 35 to 100° C.

8. A process according to claim 1 wherein the substituted aryl halide compound, nickel catalyst, and an optional solvent are initially charged at from 0 to 25° C., the resultant mixture is then brought to the reaction temperature, and the Grignard reagent is then metered in.

9. A process according to claim 1 wherein only part of the substituted aryl halide compound is initially charged together with the nickel catalyst and an optional solvent and the remainder of the substituted aryl halide compound is added during introduction of the Grignard reagent.

10. A process for preparing precursor materials for nickel catalysts comprising loading a support material in the presence of an aqueous solution of one or more nickel(II) salts and a base.

11. A process according to claim 10 wherein the loaded support material is heated at from 150 to 400° C.

12. A process according to claim 10 wherein the loaded support material is heated at from 170 to 300° C.

13. A process for preparing nickel catalysts comprising loading a support material in the presence of an aqueous solution of one or more nickel(II) salts and a reducing agent.

14. A process according to claim 13 wherein the reducing agent contains hydrazine or formaldehyde.

15. A process for preparing nickel catalysts comprising reducing a loaded support material according to claim 10 by addition of a reducing agent.

16. A process according to claim 15 wherein the reduction is carried out using hydrogen, organolithium compounds, or a Grignard reagent.

17. A process comprising preparing aryl compounds from halogenoaromatics and Grignard compounds in the presence of a nickel catalyst according to claim 13.

18. A process comprising preparing aryl compounds from halogenoaromatics and Grignard compounds in the presence of a nickel catalyst according to claim 15.
